(19) United States
(12) Patent Application Publication
(10) Pub. No.: US 2025/0191599 A1
(43) Pub. Date: Jun. 12, 2025

(54) System and Method for Secure Speech Feature Extraction

(71) Applicant: Microsoft Technology Licensing, LLC, Redmond, WA (US)

(72) Inventors: Dushyant Sharma, Mountain View, CA (US); Patrick A. Naylor, Reading (GB); Sri Harsha Dumpala, Halifax (CA); Chandramouli Shama Sastry, Halifax (CA)

(21) Appl. No.: 18/532,871

(22) Filed: Dec. 7, 2023

(51) Int. Cl. G10L 21/013; G10L 17/02; G10L 17/04; G10L 17/18

(52) U.S. Cl. CPC G10L 21/013; G10L 17/02; G10L 17/04; G10L 17/18; G10L 2021/0135

(57) ABSTRACT

A method, computer program product, and computing system for secure speech feature extraction. A speech signal comprising content information and speaker information is received and a component of the speaker information is altered to generate an augmented voice signal. In a first neural network, first embeddings of the received voice signal are generated. In a second neural network, second embeddings of the received voice signal having minimized speaker information based on the augmented voice signal are generated. The second neural network is trained to generate the second embeddings to be similar to the first embeddings generated by the first neural network.

### BACKGROUND

Machine learning-based speech feature extraction techniques have been developed with the purpose of capturing more relevant information in a compact representation that is learned from the data directly. The use of such feature extraction techniques allows for simpler neural architectures to be used for downstream tasks and comes with improved accuracy for the target domain related tasks. However, since these techniques are typically designed to model all the useful aspects of a speech signal, they also capture speaker related information.

### BRIEF DESCRIPTION OF THE DRAWINGS

FIG. 1 is a flow chart of an implementation of a secure speech feature extraction process;

FIG. 2 is a diagrammatic view of an implementation of the secure speech feature extraction process;

FIG. 3 is a flow chart of another implementation of a secure speech feature extraction process;

FIG. 4 is a diagrammatic view of another implementation of the secure speech feature extraction process;

FIG. 5 is a graph showing a result of the execution of the secure speech feature extraction process;

FIG. 6 is a graph showing another result of the execution of the secure speech feature extraction process;

FIG. 7 is a graph showing yet another result of the execution of the secure speech feature extraction process;

FIG. 8 is an example graph showing how the data in FIGS. 5-7 is represented; and

FIG. 9 is a diagrammatic view of a computer system and the secure speech feature extraction process coupled to a distributed computing network.

Like reference symbols in the various drawings indicate like elements.

### DETAILED DESCRIPTION

As will be discussed in greater detail below, implementations of the present disclosure are directed to training neural feature extraction systems to develop speech features that are invariant to speaker information, i.e. those that minimize or do not capture speaker information while preserving the content information. This is done with a mix of training data perturbations/normalizations and loss function constraints such that the learned representations are invariant to the voice of the speaker. The data perturbations include speaker conversion, pitch flattening and shifting and vocal tract length normalization and are most useful in a self-supervised (or unsupervised) learning setup (where content and speaker labels for the data are not available). The loss function constraints are further utilized in a supervised or semi-supervised setup (where transcriptions and speaker labels are either available or can be estimated) and include terms such as an increase in dispersion of the features according to speaker information, like gender or pitch (i.e. minimizing the clustering of features into speaker groups), speaker misidentification, for example, when used as part of a speaker verification/recognition system (i.e. the inability of a model to identify the correct speaker's identify from the features), and content clustering (i.e. the features representing the same words should cluster together).

The advantage of this approach is that it allows downstream tasks to be built based on the new features to be acoustically de-identified by design (i.e. a person's voice characteristics cannot be extracted from these features). This then allows for a more secure ASR system, for example.

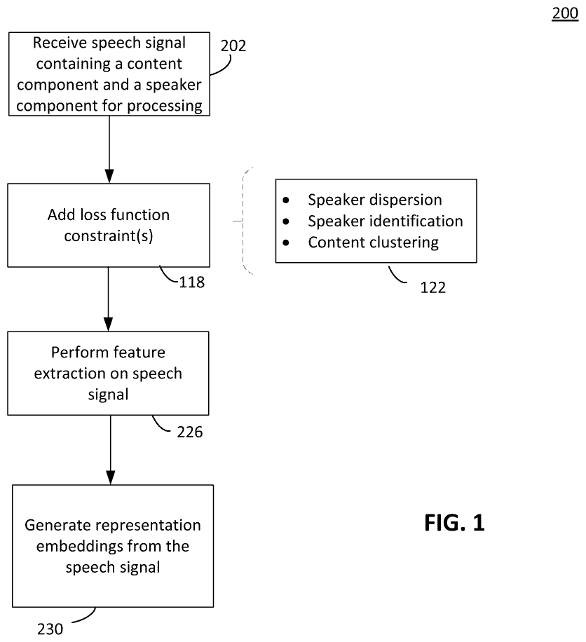

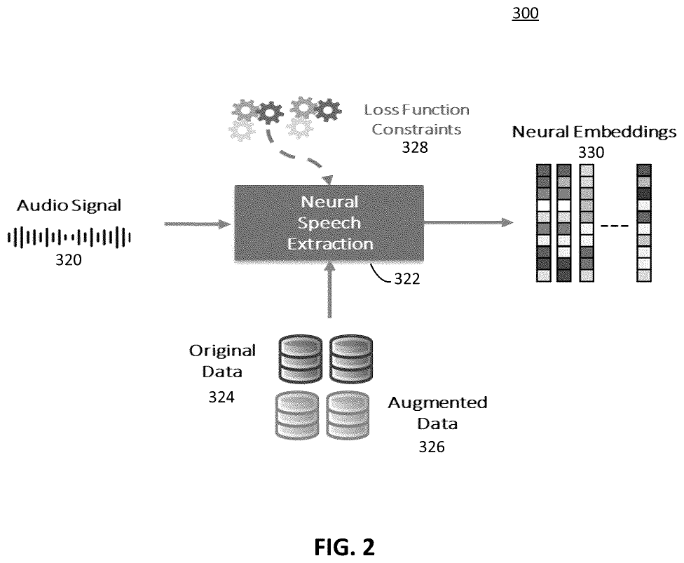

Referring now to FIGS. 1 and 2, an implementation of the disclosure will be described. FIG. 1 is a flow chart 200 showing the operation of supervised or semi-supervised system secure speech feature extraction system 300 shown in FIG. 2. A voice signal, such as speech signal 320 is received at the system 200, 202. Signal 320 includes a content information component and a speaker information component. Content information generally includes any information that relates to the intelligible content in the audio (i.e. what is spoken), including background acoustics etc. Before any further processing, the content information also includes the speaker information. Speaker information includes, for example, the aspect of a voice signal that identifies a person by the acoustic features (i.e. the voice of the speaker) as determined by factors including pitch and pitch variation, vocal timbre, tempo and other accent-related characteristics.

In a supervised or semi-supervised system, where text transcriptions and speaker information are available, for example, in the form of original data 324 and/or augmented data 326, altering the speaker component includes processing by adding 118 loss function constraints 328 to the optimization of the neural speech extraction system 322, resulting in an augmented voice signal. These loss function constraints are added to the optimization of the neural speech extraction system 322 in an adversarial manner to discourage network 322 from learning speaker information. A feature extraction process is performed 226 in network 322 to generate 230 representation embeddings 330 that are speaker invariant. The feature extraction is an optional step that is applied to the signal 320 to generate an intermediate signal that is more suitable for the network 322 (for example, to convert the input waveform into the frequency domain representation). Feature extraction is a preprocessing step that involves converting raw audio data into a form that can be effectively analyzed and processed by machine learning models. It aims to extract relevant acoustic features from the audio signal while reducing its dimensionality. The extracted features provide valuable information about the speech signal, making it easier for ASR systems to recognize and transcribe spoken words. In an implementation of the disclosure, loss function constraints 328 can include, but are not limited to, speaker dispersion (the opposite of clustering), speaker identification (or misidentification), or content clustering, 122.

Speaker dispersion is a concept that relates to the distribution of speakers or the variability of different speakers' characteristics within a given dataset or speech corpus. The system 300 uses speaker dispersion as a loss function constraint to prevent embeddings 330 from clustering according to speaker information. Speaker identification is the process of determining and verifying the identity of a speaker based on their unique vocal characteristics and voiceprints. The system 300 uses speaker identification as a loss function constraint to prevent the network 322 from using embeddings to train the network for the purpose of speaker identification. For example, the system 300 may use a speaker verification loss in an adversarial manner. Content clustering refers to the process of grouping or categorizing spoken content into distinct clusters based on their semantic or topic-related similarities. The system 300 uses content clustering as a loss function constraint to encourage the network to cluster content information of the voice signal rather than the speaker information.

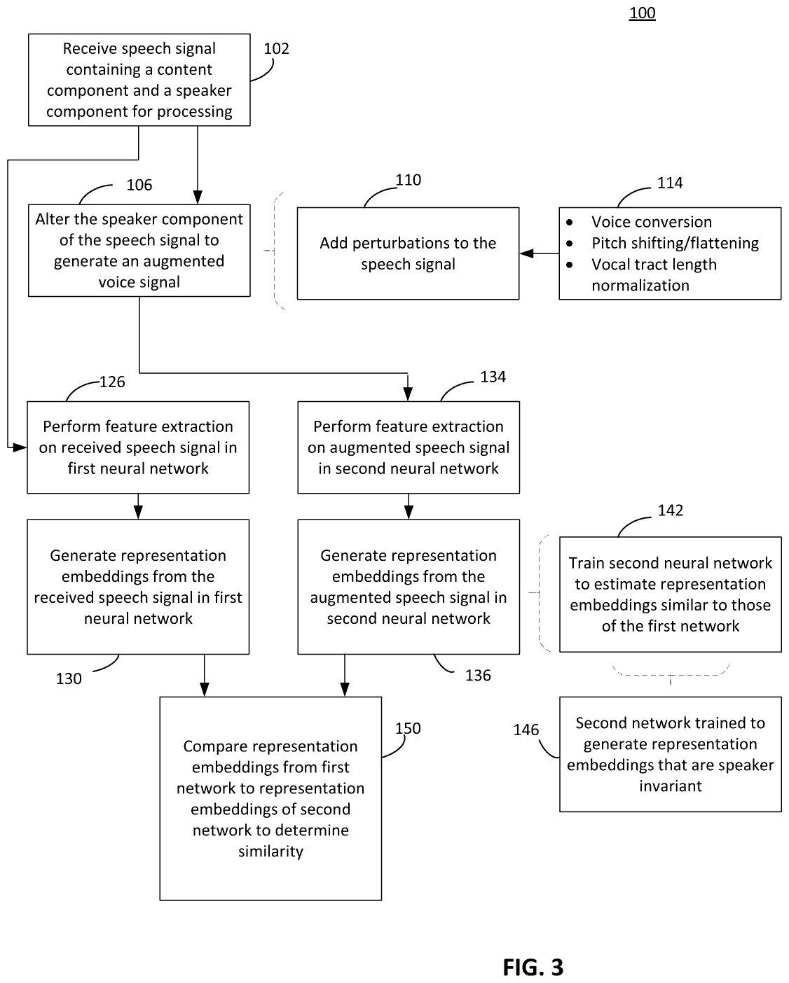

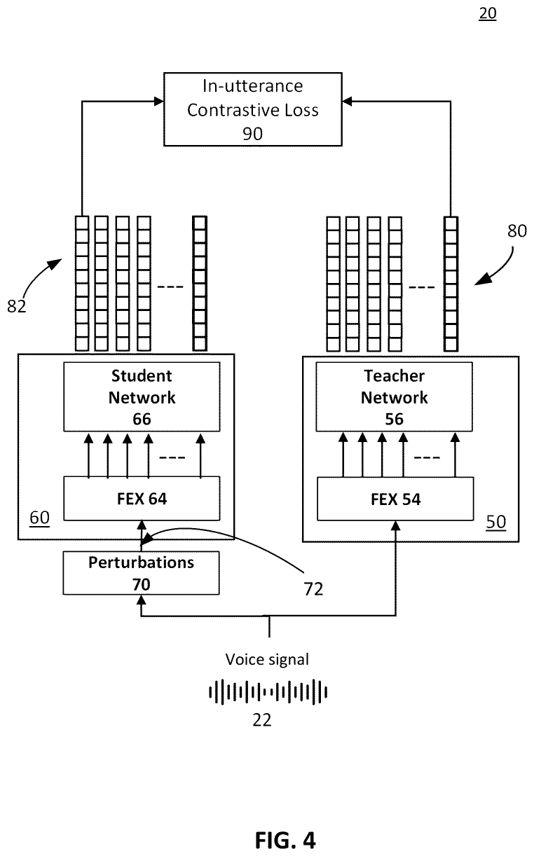

Referring now to FIGS. 3 and 4, another implementation of the disclosure will be described. FIG. 3 is a flow chart 100 showing the operation of unsupervised secure speech feature extraction system 20 shown in FIG. 4. A voice signal 22 is received at the system 20, 102. Signal 20 includes a content information component and a speaker information component. Content information generally includes any information that relates to the intelligible content in the audio (i.e. what is spoken), including background acoustics etc. Before any further processing, the content information also includes the speaker information. Speaker information includes, for example, the aspect of a voice signal that identifies a person by the acoustic features (i.e. the voice of the speaker) as determined by factors including pitch and pitch variation, vocal timbre, tempo and other accent-related characteristics.

System 20 includes a first neural network 50 and a second neural network 60. First neural network 50 and second neural network 60 operate together in a manner referred to in the relevant field as a “teacher-student network.” As is known in the relevant art, a teacher-student network refers to a training approach that leverages the concept of knowledge transfer between two neural networks: a teacher network and a student network. This technique is often used to improve the performance of machine learning systems and is inspired by the broader field of deep learning, where it is known as knowledge distillation. The teacher-student network setup works as follows: The teacher network is typically a well-established, larger, and more complex ASR model that has achieved high accuracy in recognizing spoken language. The student network is a smaller, more compact model that is trained to mimic the behavior of the teacher network. During the training process, the teacher network serves as the “teacher” by providing soft targets or guidance to the student network. The teacher network's soft targets include not only the final ASR transcription but also the intermediate representations, such as the output probabilities for phonemes, words, or sub word units. These soft targets are used to train the student network, allowing it to learn not just the final transcription but also the nuances and decision-making processes of the teacher network. Accordingly, the teacher-student network approach in ASR is a valuable technique for model compression and performance enhancement. It allows for the transfer of knowledge from a larger, more accurate ASR model to a smaller, more efficient model, thereby improving the ASR system's overall effectiveness and efficiency.

The received voice signal 22 is input to first neural network 50, where, in an implementation, a feature extraction operation 54 is performed, 126. Feature extraction is a preprocessing step that involves converting raw audio data into a form that can be effectively analyzed and processed by machine learning models. It aims to extract relevant acoustic features from the audio signal while reducing its dimensionality. The extracted features provide valuable information about the speech signal, making it easier for machine learning systems to recognize and transcribe spoken words. In this implementation, feature extraction is a pre-processing task for the teacher network 56 designed to feed in the data in a more convenient form to the teacher network. Teacher network 56 then estimates a representation sequence from which learnt features are extracted (either directly or by a small transformation). In another implementation, the feature extraction process is optional.

Commonly used acoustic features in ASR include Mel-frequency cepstral coefficients (MFCCs), filter banks, and various spectral features. These features capture characteristics of the speech signal related to pitch, timbre, and other acoustic properties. Feature extraction techniques also include methods for representing short segments of speech, known as frames or windows, as they evolve over time, taking into account the dynamic nature of speech. Once the features are extracted, they are typically organized into sequences that can be fed into machine learning models such as Hidden Markov Models (HMMs) or deep neural networks (DNNs). These models learn to recognize patterns in the extracted features and map them to phonemes, words, or other linguistic units.

The results of the feature extraction function 54 are then input to teacher network 56, which generates 130 an embedding 80, that is representative of the voice signal 22. Representation embedding refers to the process of transforming and encoding speech data into a numerical representation, often in the form of a fixed-size vector, which captures the relevant features of the audio signal. The goal of representation embedding in speech processing systems is to create a compact and meaningful representation of the acoustic features of speech, which can then be used for various tasks such as speech recognition, speaker identification, or language understanding. These features are then processed and transformed using techniques like neural networks or statistical modeling to create a fixed-dimensional embedding that encapsulates important information about the spoken content. Deep learning techniques, such as recurrent neural networks (RNNs), convolutional neural networks (CNNs), and transformer models, are commonly used for representation embedding in speech processing systems. These models can capture complex patterns and dependencies in the audio data, learning hierarchical representations that are useful for subsequent recognition tasks. Once the representation embedding is obtained, it serves as the input to ASR models, which then use this condensed and meaningful representation to transcribe spoken language into textual form.

In this implementation, as described herein, through multiple iterations of training of this system, the representation embeddings become speaker invariant because of contrastive learning and the perturbations performed on the student network (described below).

Voice signal 22 is also input to the second neural network 60. However, prior to the processing of the signal, the speaker component of the signal 22 is altered 106 in a way that alters certain aspects of the voice signal to help train the second neural network to become speaker invariant. In a self-supervised or unsupervised system, meaning that no speaker or content labels are available, such as that shown in FIG. 2, altering the speaker component includes adding perturbations to the signal 110, resulting in an augmented voice signal 72. In an implementation of the disclosure, such perturbations can include, but are not limited to, voice conversion, pitch shifting/flattening, and vocal tract length normalization 114.

Voice conversion refers to a technology that aims to modify or transform a speaker's voice from one characteristic or identity to another while retaining the linguistic content of the speech. This process involves altering various acoustic features of the original speech signal to make it sound as if it were spoken by a different person. Voice conversion can have numerous applications, including anonymity preservation, improving speaker diversity in synthetic speech, or making voice commands more engaging in virtual assistants. Voice conversion typically relies on machine learning techniques, such as deep neural networks, to learn the relationships between the acoustic features of one speaker's voice and another's. The system can then apply these learned transformations to convert the voice while preserving, to a significant extent, the phonetic and prosodic content of the original speech. As such, voice conversion is primarily concerned with changing the acoustic properties of speech. In an implementation, voice conversion can include converting the voice of the speaker of voice signal 22 to that of a normalized or registered speaker, such as a virtual assistant. Voice conversion also includes gender switching, such as converting an utterance spoken by a male to the voice of a female.

Pitch shifting, also known as pitch alteration, is a digital audio processing technique that modifies the pitch (frequency) of an audio signal without significantly affecting its duration or speed. This means that the time axis of the audio remains the same, but the perceived musical or vocal pitch is raised or lowered. When the pitch is increased, it's referred to as “pitch shifting up,” and when it's decreased, it's called “pitch shifting down.”

Pitch shifting can be achieved using various methods, including time-domain techniques and frequency-domain techniques. Time-domain methods, like the WSOLA (Waveform Similarity Overlap and Add) algorithm, stretch or compress the audio waveform to change its pitch, while frequency-domain methods, like the phase vocoder, manipulate the audio's spectral representation to achieve pitch alteration. Pitch flattening involves reducing variations in pitch to remove prosodic information to make a voice sound more monotonous, flat, or robotic.

Vocal tract length normalization (VTLN) is a technique used in speech processing to account for variations in the vocal tract lengths of different speakers when dealing with speech signals. The vocal tract is the passage through which speech is produced and modified, and its length varies from person to person. These variations can affect the frequency characteristics of the speech signal, making it challenging for ASR systems to accurately recognize or identify speakers. VTLN is a method of compensating for these variations by normalizing the frequency content of the speech signal. It involves transforming the speech signal to make it as if it were produced by a reference vocal tract length. By applying a VTLN transformation, the ASR or other speech processing system can better adapt to different speakers, making it more robust and accurate in recognizing speech across diverse vocal tract lengths. VTLN also can help make these systems invariant to or less effected by speaker variation.

Once perturbations are added to the voice signal at 106 to generate an augmented voice signal 72, in an implementation, augmented voice signal 72 is input to second neural network 60, where a feature extraction operation 64 is performed, 134 as described above with reference to network 50. The results of the feature extraction function 64 are then input to student network 66, which generates 136 representation embeddings 82. In accordance with an implementation of the disclosure, in the generation of the representation embeddings, the second (student) network 66 is trained 142 to estimate embeddings similar to those of the first (teacher) network 56.

As discussed above with regard to the teacher-student network architecture, the second (student) network 66 is trained to estimate representation embeddings similar to those of the first (teacher) network. Therefore, by altering the voice signal 22 to form augmented signal 72 by adding perturbations, because the second (student) network strives to generate embeddings that are similar to the first (teacher) network, it learns to ignore the different forms of the altered speaker information when generating the embeddings 82. Accordingly, through iterations of training, by contrastive learning, embeddings 82 generated by the second (student) network become speaker invariant and include less and less speaker information and eventually encapsulate only the content information. To further the training process, the representation embeddings 80 from the first network 50 are compared to the representation embeddings 82 from the second network 60 to determine the similarity of the embeddings to gauge the speaker invariance of the second network 150. This can be done by measuring, for example, a contrastive loss between the signals. Signals resulting from the process described above contain content-based information while discarding the information pertaining to the speaker.

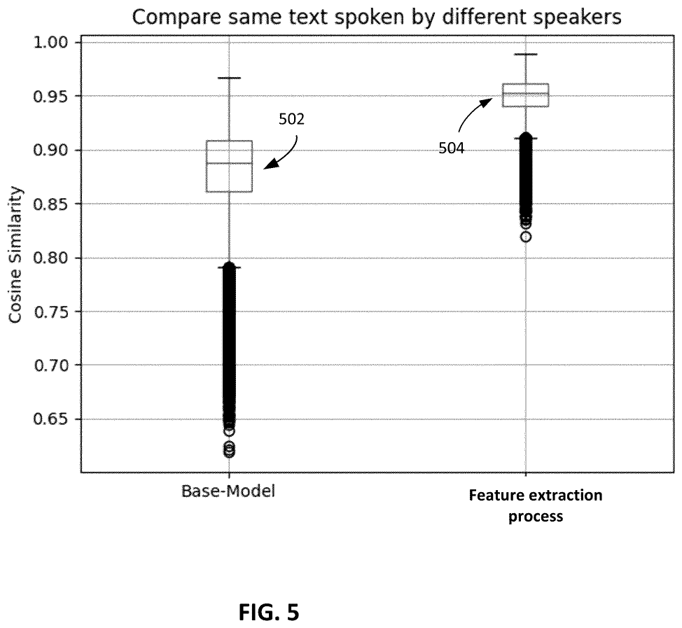

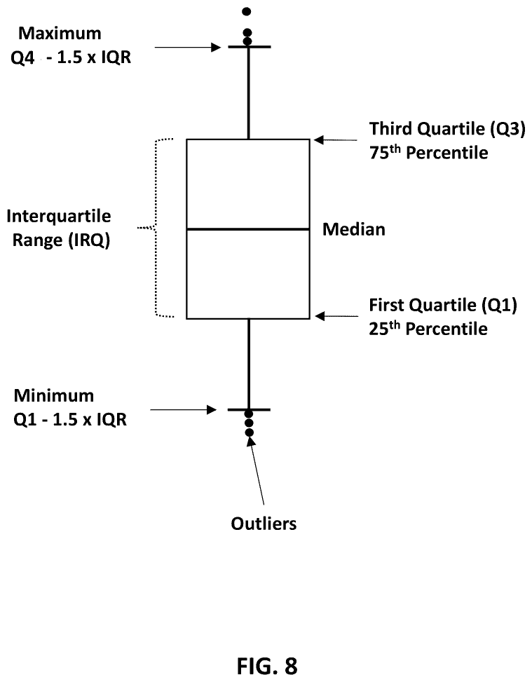

Referring now to FIGS. 5-7, results of examples of processing performed within system 20 will be discussed. In these graphs, a comparison is shown between a baseline ASR system and an implementation of the ASR system of the disclosure showing how the disclosed system performs when generating embeddings in a speaker invariant manner. The results are shown as a cosine similarity function, which is a mathematical measure often used in ASR and natural language processing to assess the similarity between two vectors or feature representations, such as those used for speech or text. This similarity metric quantifies the cosine of the angle between two vectors, with a resulting value ranging from −1 (perfectly dissimilar) to 1 (perfectly similar), where 0 indicates no similarity. Based on the foregoing, smaller changes for multiple samples being processed indicates reductions of reactions to the speaker information by the second network, which indicates the minimization of reaction to the speaker information by the second network. FIG. 8 is an example graph showing how the data in FIGS. 5-7 is represented. The box in the graph represents the interquartile range (IQR) between the first (25th) quartile Q1 and the third (75th) quartile Q3, around the median. A minimum data line Q1 on the graph represents 1.5 X IQR and a maximum data line Q4 on the graph represents 1.5 X IQR. The dots below and above Q1 and Q4 represent outliers. An outlier is a number that is less than Q1 or more than Q3 by more than 1.5 times the IQR.

FIG. 5 is a graph showing results of the disclosed system when processing the same text spoken by different speakers. Shown at 502 is the cosine similarity of the embeddings of the baseline system. As shown, the result is a broad IQR between approximately 0.86 and 0.91. In contrast, at 504 is the cosine similarity of the embeddings when the same text spoken by different speakers is processed according to an implementation of the disclosure. As shown, not only is the range smaller (approximately 0.94 to 0.96), indicating that the trained second network is reacting less to changes in the speakers' voices, the cosine similarity is higher, indicating that the trained system “sees” the different speaker samples as more similar to each other (values closer to “1.0”), which is a result of the network being trained to be speaker invariant.

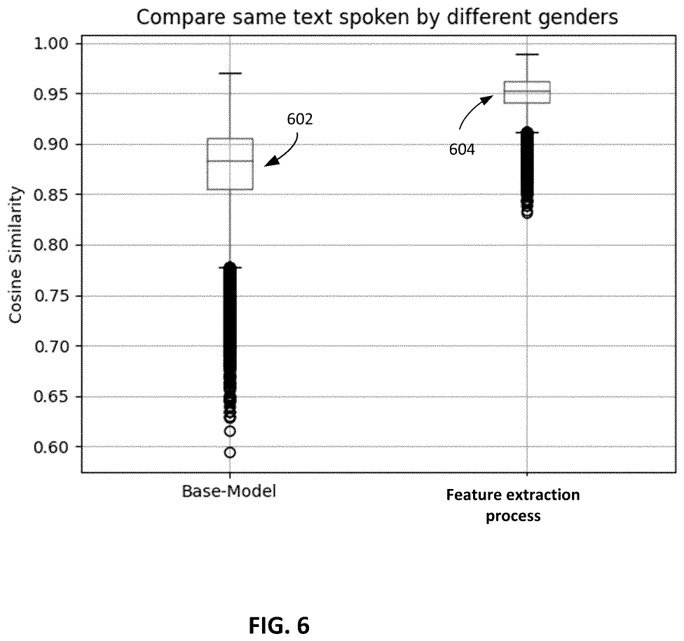

FIG. 6 is a graph showing results of the disclosed system when processing the same text spoken by speakers of different genders. Shown at 602 is the cosine similarity of the embeddings of the baseline system. As shown, the result is a broad range between approximately 0.85 and 0.90. In contrast, at 604 is the cosine similarity of the embeddings when the same text spoken by speakers of different genders is processed according to an implementation of the disclosure. As shown, not only is the range smaller (approximately 0.94 to 0.96), indicating that the trained second network is reacting less to changes in the speakers' genders, the cosine similarity is higher, indicating that the trained system “sees” the different speaker gender samples as more similar to each other (values closer to “1.0”), which is a result of the network being trained to be speaker invariant.

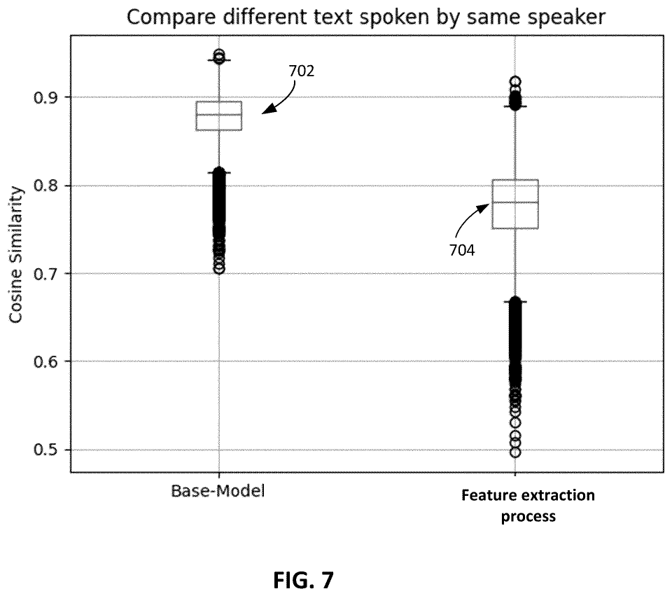

FIG. 7 is a graph showing results of the disclosed system when processing different text spoken by the same speaker. Shown at 702 is the cosine similarity of the embeddings of the baseline system. As shown, the result is a narrow range between approximately 0.86 and 0.89. This is because the baseline system recognizes the similarity in the voice of the speaker and thus groups the embeddings to indicate a higher similarity of the embeddings. This means that the baseline system recognizes that these samples are likely from the same speaker. In contrast, at 704 is the cosine similarity when the different text is spoken by the same speaker is processed according to an implementation of the disclosure. As shown, the range is broader (approximately 0.75 to 0.81), indicating that the trained second network is reacting less to the similarity of the speaker's voice, meaning that the system doesn't consider the text as being spoken by the same speaker. Further, the cosine similarity is lower, indicating that the trained system “sees” the speaker samples as less similar to each other (values closer to “0”), which is a result of the network being trained to be speaker invariant.

Accordingly, by altering a received voice signal by introducing perturbations and/or loss function constraints during the training of an ASR system, the system can be trained to become speaker invariant while preserving the content information of the signal. This enables the removal of identifying speaker information from the voice signal and the processing of the voice signal in a secure manner in downstream ASR systems. While specific examples of perturbations and loss function constraints have been described to illustrate the function of implementations of the disclosure, it will be understood that other methods of altering the voice signal or introducing a loss factor may be used to carry out the operation of the disclosed system and method.

### System Overview:

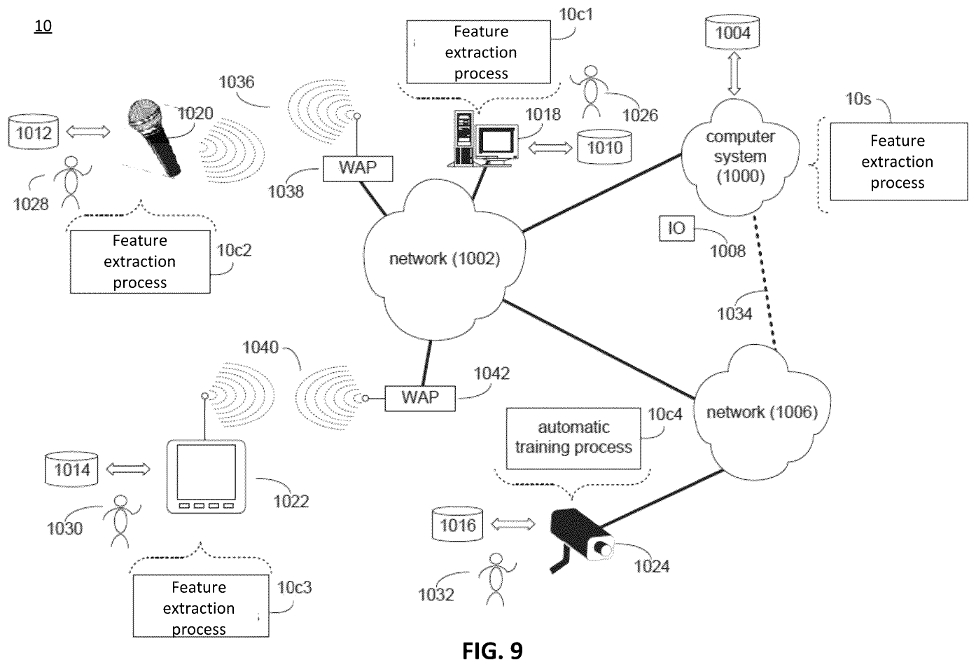

Referring to FIG. 9, there is shown a feature extraction process 10. Feature extraction process 10 may be implemented as a server-side process, a client-side process, or a hybrid server-side/client-side process. For example, feature extraction process 10 may be implemented as a purely server-side process via computational cost reduction process 10s. Alternatively, feature extraction process 10 may be implemented as a purely client-side process via one or more of feature extraction process 10c1, feature extraction process 10c2, feature extraction process 10c3, and feature extraction process 10c4. Alternatively still, feature extraction process 10 may be implemented as a hybrid server-side/client-side process via feature extraction process 10s in combination with one or more of feature extraction process 10c1, feature extraction process 10c2, feature extraction process 10c3, and feature extraction process 10c4.

Accordingly, feature extraction process 10 as used in this disclosure may include any combination of feature extraction process 10, feature extraction process 10c1, feature extraction process 10c2, feature extraction process 10c3, and feature extraction process 10c4.

Feature extraction process 10s may be a server application and may reside on and may be executed by a computer system 1000, which may be connected to network 1002 (e.g., the Internet or a local area network). Computer system 1000 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a minicomputer, a mainframe computer, a RAID device and a NAS system. The various components of computer system 1000 may execute one or more operating systems.

The instruction sets and subroutines of computational cost reduction process 10s, which may be stored on storage device 1004 coupled to computer system 1000, may be executed by one or more processors (not shown) and one or more memory architectures (not shown) included within computer system 1000. Examples of storage device 1004 may include but are not limited to: a hard disk drive; a RAID device; a random-access memory (RAM); a read-only memory (ROM); and all forms of flash memory storage devices.

Network 1002 may be connected to one or more secondary networks (e.g., network 1004), examples of which may include but are not limited to: a local area network; a wide area network; or an intranet, for example.

Various IO requests (e.g., IO request 1008) may be sent from feature extraction process 10s, feature extraction process 10c1, feature extraction process 10c2, feature extraction process 10c3 and/or feature extraction process 10c4 to computer system 1000. Examples of IO request 1008 may include but are not limited to data write requests (i.e., a request that content be written to computer system 1000) and data read requests (i.e., a request that content be read from computer system 1000).

The instruction sets and subroutines of feature extraction process 10c1, feature extraction process 10c2, feature extraction process 10c3 and/or computational cost reduction process 10c4, which may be stored on storage devices 1010, 1012, 1014, 1016 (respectively) coupled to client electronic devices 1018, 1020, 1022, 1024 (respectively), may be executed by one or more processors (not shown) and one or more memory architectures (not shown) incorporated into client electronic devices 1018, 1020, 1022, 1024 (respectively). Storage devices 1010, 1012, 1014, 1016 may include but are not limited to: hard disk drives; optical drives; RAID devices; random access memories (RAM); read-only memories (ROM), and all forms of flash memory storage devices. Examples of client electronic devices 1018, 1020, 1022, 1024 may include, but are not limited to, personal computing device 1018 (e.g., a smart phone, a personal digital assistant, a laptop computer, a notebook computer, and a desktop computer), audio input device 1020 (e.g., a handheld microphone, a lapel microphone, an embedded microphone (such as those embedded within eyeglasses, smart phones, tablet computers and/or watches) and an audio recording device), display device 1022 (e.g., a tablet computer, a computer monitor, and a smart television), a hybrid device (e.g., a single device that includes the functionality of one or more of the above-references devices; not shown), an audio rendering device (e.g., a speaker system, a headphone system, or an earbud system; not shown), and a dedicated network device (not shown).

Users 1026, 1028, 1030, 1032 may access computer system 1000 directly through network 1002 or through secondary network 1006. Further, computer system 1000 may be connected to network 1002 through secondary network 1006, as illustrated with link line 1034.

The various client electronic devices (e.g., client electronic devices 1018, 1020, 1022, 1024) may be directly or indirectly coupled to network 1002 (or network 1006). For example, personal computing device 1018 is shown directly coupled to network 1002 via a hardwired network connection. Further, machine vision input device 1024 is shown directly coupled to network 1006 via a hardwired network connection. Audio input device 1022 is shown wirelessly coupled to network 1002 via wireless communication channel 1036 established between audio input device 1020 and wireless access point (i.e., WAP) 1038, which is shown directly coupled to network 1002. WAP 1038 may be, for example, an IEEE 802.11a, 802.11b, 802.11 g, 802.11n, Wi-Fi, and/or any device that is capable of establishing wireless communication channel 1036 between audio input device 1020 and WAP 1038. Display device 1022 is shown wirelessly coupled to network 1002 via wireless communication channel 1040 established between display device 1022 and WAP 1042, which is shown directly coupled to network 1002.

The various client electronic devices (e.g., client electronic devices 1018, 1020, 1022, 1024) may each execute an operating system, wherein the combination of the various client electronic devices (e.g., client electronic devices 1018, 1020, 1022, 1024) and computer system 1000 may form modular system 1044.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a speech signal comprising content information and speaker information, resulting in a received speech signal;
altering a component of the speaker information to generate an augmented received speech signal; and
generating, using machine learning and based on the augmented received speech signal, a first representation of the received speech signal having minimized speaker information.

2. The computer-implemented method of claim 1, wherein altering a component of the speaker information comprises adding a perturbation to the speech signal.

3. The computer-implemented method of claim 2, wherein the perturbation includes at least one of voice conversion, pitch shifting, and vocal tract length normalization.

4. The computer-implemented method of claim 1, wherein altering a component of the speaker information comprises adding a loss function constraint to a processing of the received speech signal.

5. The computer-implemented method of claim 4, wherein the loss function constraint includes at least one of speaker dispersion, speaker identification, and content clustering.

6. The computer-implemented method of claim 1, wherein generating the first representation of the received speech signal having minimized speaker information comprises performing a feature extraction process on the received augmented speech signal to generate first extracted features and generating first embeddings from the first extracted features.

7. The computer-implemented method of claim 6, further comprising generating a second representation of the received speech signal.

8. The computer-implemented method of claim 7, wherein generating the second representation of the received audio signal comprises performing a feature extraction process on the received speech signal to generate second extracted features and generating second embeddings from the second extracted features.

9. The computer-implemented method of claim 8, further including comparing the first embeddings to the second embeddings to determine a similarity therebetween.

10. The computer-implemented method of claim 8, wherein performing the feature extraction process on the augmented received speech signal to generate first extracted features and generating first embeddings from the first extracted features is performed in a first neural network.

11. The computer-implemented method of claim 10, wherein performing the feature extraction process on the received voice signal to generate second extracted features and generating second embeddings from the second extracted features is performed in a second neural network.

12. The computer-implemented method of claim 10, further comprising training the first neural network to generate embeddings that are invariant to the speaker information based on the audio signal having minimized speaker information.

13. The computer-implemented method of claim 11, further comprising training the first neural network to generate the first embeddings to be similar to the second embeddings generated by the second neural network.

14. A computing system comprising:
a memory; and
a processor to:
receive a speech signal comprising content information and speaker information, resulting in a received speech signal;
alter a component of the speaker information to generate an augmented voice signal;
generating, using machine learning in a first neural network, first embeddings of the received voice signal;
generating, using machine learning in a second neural network, second embeddings of the received voice signal having minimized speaker information based on the augmented voice signal; and
training the second neural network to generate the second embeddings to be similar to the first embeddings generated by the first neural network.

15. The computing system of claim 14 wherein altering a component of the speaker information comprises adding a perturbation to the voice signal.

16. The computer-implemented method of claim 15, wherein the perturbation includes at least one of voice conversion, pitch shifting, and vocal tract length normalization.

17. The computer-implemented method of claim 14, wherein altering a component of the speaker information comprises adding a loss function constraint to a processing of the voice signal.

18. The computer-implemented method of claim 17, wherein the loss function constraint includes at least one of speaker dispersion, speaker identification, and content clustering.

19. A computer program product residing on a non-transitory computer readable medium having a plurality of instructions stored thereon which, when executed by a processor, cause the processor to perform operations comprising:
receiving a speech signal comprising content information and speaker information, resulting in a received speech signal;
altering a component of the speaker information to generate an augmented speech signal;
generating, using machine learning in a first neural network, first embeddings of the received speech signal;
generating, using machine learning in a second neural network, second embeddings of the received speech signal having minimized speaker information based on the augmented speech signal; and
training the second neural network to generate second embeddings that are invariant to the speaker information based on the augmented speech signal having minimized speaker information.

20. The computer program product of claim 18, wherein altering a component of the speaker information comprises adding a perturbation to the received speech signal.
